(19) United States
(12) Patent Application Publication
(10) Pub. No.: US 2018/0070388 A1
(43) Pub. Date: Mar. 8, 2018

(54) SYSTEM AND METHOD FOR VEHICULAR AND MOBILE COMMUNICATION DEVICE CONNECTIVITY

(71) Applicants: Hyundai America Technical Center, Inc, Superior Township, MI (US); Hyundai Motor Company, Seoul (KR); Kia Motors Corporation, Seoul (KR)

(72) Inventors: Joshua Maxwell, Superior Township, MI (US); Joseph Jabour, Northville, MI (US); Alex Albanese, Ypsilanti, MI (US); Joseph Steffey, Brownstown Township, MI (US); Jennifer Wang, San Gabriel, CA (US); Mallory Stallworth, Plymouth, MI (US); Chadd Price, Livonia, MI (US)

(21) Appl. No.: 15/255,442

(22) Filed: Sep. 2, 2016

(51) Int. Cl. H04W 76/02; H04L 12/40; B60R 1/00; B60K 35/00; G01C 21/36

(52) U.S. Cl. CPC H04W 76/02; H04L 12/40; B60R 1/00; B60K 35/00; G01C 21/362; H04L 2012/40273; G06F 3/017; B60R 2300/804; B60R 2300/8033; B60K 2350/1028; B60K 2350/1052; B60K 2350/1076; H04L 2012/40215

(57) ABSTRACT

A method includes: establishing a connection between a mobile communication device and a controller area network (CAN) bus in a CAN of a vehicle; receiving, via the established connection, information from the mobile communication device, including image information acquired by a camera of the mobile communication device; displaying vehicle information and a representation of an interface of the mobile communication device based on the information received from the mobile communication device in a display area of the vehicle; receiving input for controlling a function of the mobile communication device; and controlling, via the established connection, the function of the mobile communication device according to the received input.

### BACKGROUND

### (a) Technical Field

The present disclosure relates generally to mobile communication device connectivity, and more particularly, to a system and method for vehicular and mobile communication device connectivity.

### (b) Background Art

As mobile communication devices (e.g., smart devices, smart phones, cell phones, tablets, PDAs, laptops, etc.) have become increasingly ubiquitous in society, mobile communication device usage and dependence has, not surprisingly, increased dramatically, particular among younger generations. Along these lines, owners of mobile communication devices have been found to place a higher ownership priority on their respective mobile communication device than other devices, even including vehicles. Therefore, it follows that the desire for connectivity to one's mobile communication device while riding in a vehicle is expanding, and especially so for drivers. By enhancing vehicular and mobile communication device connectivity, user convenience and accessibility can be increased, while minimizing security risks and driver distraction.

### SUMMARY OF THE DISCLOSURE

The present disclosure provides techniques for enabling seamless in-vehicle connectivity to mobile communication devices. Once a user (i.e., driver or passenger) initiates a connection between his or her mobile communication device and the vehicle, the user can conveniently interact with the device using a variety of techniques throughout the vehicle cabin. The user can view a representation of the mobile communication device's interface displayed in the vehicle (e.g., on the dashboard), such that it is integrated with vehicular information, such as heating, ventilating, and air conditioning (HVAC) controls, radio controls, navigational features, and the like. Further, the user can customize the layout of the in-vehicle interface by manually rearranging the placement of the displayed mobile communication device and vehicle information. Also, the existing hardware of the mobile communication device can be leveraged to provide additional features in the vehicle, such as safety-related features, navigational features, and other convenience-related functionality.

According to embodiments of the present disclosure, a method includes: establishing a connection between a mobile communication device and a controller area network (CAN) bus in a CAN of a vehicle; receiving, via the established connection, information from the mobile communication device, including image information acquired by a camera of the mobile communication device; displaying vehicle information and a representation of an interface of the mobile communication device based on the information received from the mobile communication device in a display area of the vehicle; receiving input for controlling a function of the mobile communication device; and controlling, via the established connection, the function of the mobile communication device according to the received input.

The method may further include controlling a function of the vehicle based on the information received from the mobile communication device.

The method may further include performing a safety-related function associated with the vehicle based on the image information acquired by the camera of the mobile communication device. The safety-related function may relate to at least one of: a lane keeping assist system (LKAS), a lane departure warning (LDW), pedestrian detection, forward collision warning (FCW), and adaptive cruise control (ACC).

The method may further include performing a navigation-related function associated with the vehicle based on navigation information acquired by the mobile communication device.

The method may further include receiving, via the established connection, additional information from the mobile communication device acquired by a hardware-based component of the mobile communication device other than the camera. The hardware-based component may include: an ambient light sensor, a global positioning system (GPS) unit, an accelerometer, a gyroscope, a microphone, a compass, or a barometer.

The input for controlling the function of the mobile communication device may include at least one of: a touch gesture of a user, a motion gesture of the user, a gaze of the user, and a sound of the user. The method may further include sensing the touch gesture at a touchscreen coupled to the display area. The method may further include identifying the motion gesture or the gaze using a camera installed in the vehicle. The method may further include identifying the motion gesture or the gaze using a camera of the mobile communication device. The user may be a driver of the vehicle.

The method may further include identifying a particular gesture which is linked with a particular function of the mobile communication device based on the received input, the action being associated with at least one of: a motion of the driver, a sound of the driver, a gaze of the driver, and an eye position of the driver.

The method may further include supplying power to the mobile communication device.

The method may further include establishing the connection between the mobile communication device and the CAN bus via a wired or wireless connection.

The method may further include establishing the connection between the mobile communication device and the CAN bus via a docking station in the vehicle. The docking station may be located behind a rear-view mirror of the vehicle.

The method may further include concurrently displaying the vehicle information and the representation of the interface of the mobile communication device in the display area.

The displayed vehicle information may be associated with at least one of: heating, ventilation, and air conditioning (HVAC) information, infotainment information, and telematics information.

The display area may include a light-emitting diode (LED)-based screen, a liquid crystal display (LCD)-based screen, or a dashboard area onto which information is projected by a projection device.

The method may further include adjusting an appearance of the displayed representation of the interface of the mobile communication device in the display area according to received input.

Furthermore, according to embodiments of the present disclosure, a system includes: a vehicle including a controller area network (CAN) bus in a CAN of the vehicle; and a mobile communication device connected to the CAN bus. The CAN bus: i) receives, via the connection, information from the mobile communication device, including image information acquired by a camera of the mobile communication device, ii) displays vehicle information and a representation of an interface of the mobile communication device based on the information received from the mobile communication device in a display area of the vehicle, iii) receives input for controlling a function of the mobile communication device, and iv) controls, via the connection, the function of the mobile communication device according to the received input.

Furthermore, according to embodiments of the present disclosure, a method includes: establishing a connection between a mobile communication device and a controller area network (CAN) bus in a CAN of a vehicle; receiving, via the established connection, information from the mobile communication device, including image information acquired by a camera of the mobile communication device; displaying vehicle information and a representation of an interface of the mobile communication device based on the information received from the mobile communication device in a display area of the vehicle; and controlling a function of the vehicle based on the information received from the mobile communication device.

Furthermore, according to embodiments of the present disclosure, a system includes: a vehicle including a controller area network (CAN) bus in a CAN of the vehicle; and a mobile communication device connected to the CAN bus. The CAN bus: i) receives, via the connection, information from the mobile communication device, including image information acquired by a camera of the mobile communication device, ii) displays vehicle information and a representation of an interface of the mobile communication device based on the information received from the mobile communication device in a display area of the vehicle, and iii) controls a function of the vehicle based on the information received from the mobile communication device.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example depiction of a technique for displaying a representation of a mobile communication device interface in a vehicle;

FIG. 2 illustrates an example diagrammatic representation of interaction between components of a vehicle and a mobile communication device; and

FIG. 3 illustrates an example diagrammatic flowchart of interaction between the CAN bus and the mobile communication device during vehicular and mobile communication device connectivity.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components.

It is understood that the term “vehicle” or “vehicular” or other similar term as used herein is inclusive of motor vehicles, in general, such as passenger automobiles including sports utility vehicles (SUV), buses, trucks, various commercial vehicles, watercraft including a variety of boats and ships, aircraft, and the like, and includes hybrid vehicles, electric vehicles, hybrid electric vehicles, hydrogen-powered vehicles and other alternative fuel vehicles (e.g., fuels derived from resources other than petroleum). As referred to herein, an electric vehicle (EV) is a vehicle that includes, as part of its locomotion capabilities, electrical power derived from a chargeable energy storage device (e.g., one or more rechargeable electrochemical cells or other type of battery). An EV is not limited to an automobile and may include motorcycles, carts, scooters, and the like. Furthermore, a hybrid vehicle is a vehicle that has two or more sources of power, for example both gasoline-based power and electric-based power (e.g., a hybrid electric vehicle (HEV)).

The term “user” may encompass any person substantially capable of interacting with a vehicle, as it is defined herein, including, but not limited to a driver, a passenger, and the like. Also, the term “mobile communication device” may encompass any portable, communication-enabled device, including, but not limited to, smart devices, smart phones, cell phones, tablets, PDAs, laptops, and so forth.

Additionally, it is understood that one or more of the below methods, or aspects thereof, may be executed or moderated by at least one controller area network (CAN) bus in a CAN of a vehicle. A CAN is a serial bus network of controllers or microcontrollers (e.g., electronic control units (ECUs)) that interconnects devices, actuators, sensors, and the like in a system (such as a vehicle, as in the present case) for real-time control applications. Vehicles typically employ a wide variety of controllers including an engine control unit and others used for transmission, airbags, anti-lock braking, cruise control, electric power steering, audio systems, power windows, doors, mirror adjustment, battery or recharging systems for electric vehicles, and so forth. The controllers may include a processor as well as a memory configured to store program instructions, where the processor is specifically programmed to execute the program instructions to perform one or more processes.

In CANs, messages are broadcast to all nodes (consisting of, e.g., a controller, a sensor, a transceiver, etc.) in the network using an identifier unique to the network. Based on the identifier, the individual nodes decide whether the message is relevant, and thus whether to process the message. Also, the nodes determine the priority of the message in terms of competition for access to the CAN bus, which allows the nodes to communicate with each other. Accordingly, the CAN bus may effectively control nodes (including the mobile communication device, as described herein) connected in the CAN by facilitating communication among the nodes and via transmission of control messages throughout the network.

Referring now to embodiments of the present disclosure, the disclosed techniques allow for seamless in-vehicle connectivity to mobile communication devices. Once a user initiates a connection between his or her mobile communication device and the vehicle, the user can conveniently interact with the device using a variety of techniques throughout the vehicle cabin, thereby eliminating the need for the driver to interact directly with the device. The user can view a representation of the mobile communication device's interface displayed in the vehicle (e.g., on the dashboard), such that it is integrated with vehicular information, such as HVAC controls, radio controls, navigational features, and the like. Further, the user may personalize the in-vehicle display of the mobile communication device information and vehicle information by manually rearranging the placement of the displayed mobile communication device and vehicle information. Also, the existing hardware of the mobile communication device can be leveraged to provide additional features in the vehicle, such as safety-related features, navigational features, and other convenience-related functionality.

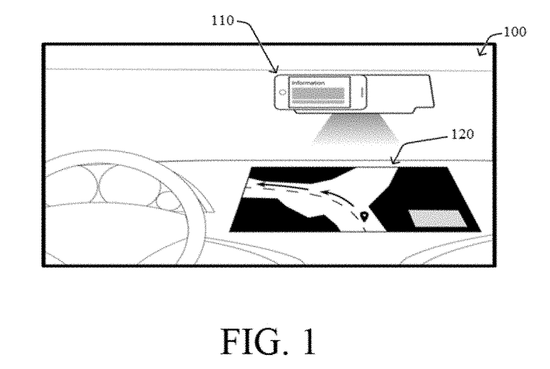

FIG. 1 illustrates an example depiction of a technique for displaying a representation of a mobile communication device interface in a vehicle. As shown in FIG. 1, a connection is established between a mobile communication device 110 of a user and a CAN bus 210 (not shown in FIG. 1) of a CAN in a vehicle 100. The mobile communication device 110 may represent a user's smart phone in many cases, but the device 110 is not limited thereto.

The mobile communication device 110 may be connected to the CAN bus 210 via a wired connection. For instance, the mobile communication device 110 may be inserted into a docking station (not shown) in the vehicle 100. The docking station may be variously located throughout the vehicle 100; though the docking station may be preferably be located behind a rear-view mirror of the vehicle 100, as demonstratively shown in FIG. 1, such that a camera of the mobile communication device 110 has a view of an exterior of the vehicle (e.g., through the windshield). The mobile communication device 110 may also be connected to the CAN bus 210 using USB, Thunderbolt, Lightning, HDMI, or any other suitable technique involving a wired connection. Notably, the vehicle 100 may transmit power (i.e., charge) the mobile communication device 110 over the wired connection. Alternatively, the mobile communication device 110 may be connected to the CAN bus 210 via a wireless connection. For instance, the mobile communication device 110 may connect to the CAN bus 210 using Bluetooth, Wi-Fi, near-field communication (NFC), or any other suitable technique involving a wireless connection.

Information may be transmitted back and forth between the mobile communication device 110 and the CAN bus 210 over the established connection. For instance, the CAN bus 210 may receive information from the mobile communication device 110 via the established connection. The information transmitted from the mobile communication device 110 to the CAN bus 210 may include any information suitable for transmission, such as, for example, information relating to the user's personal data, contacts, calendar, emails, messages, phone calls, applications, and so forth. Further, the transmitted information may include information acquired by a hardware-based component of the mobile communication device 110, such as, for example, a camera, an ambient light sensor, a global positioning system (GPS) unit, an accelerometer, a gyroscope, a microphone, a compass, a barometer, and so forth. The information acquired by a hardware-based component of the mobile communication device 110 may have been previously acquired (before connection to the CAN bus 210) or acquired in real-time (after connection to the CAN bus 210). The information transmitted by the mobile communication device 110 can then be used by the CAN bus 210 for controlling a function of the vehicle 100, as described in greater detail below. Conversely, the CAN bus 210 may transmit information to the mobile communication device 110, such as control messages, via the established connection. For instance, the CAN bus 210 may control a function of the mobile communication device 110 according to received input, as similarly described in greater detail below.

Additionally, the CAN bus 210 can cause a representation of an interface of the mobile communication device 110 to be displayed in a display area 120 of the vehicle 100. The representation of the interface of the mobile communication device 110 as displayed in the display area 120 may be based on the information received at the CAN bus 210 from the mobile communication device 110. For instance, as demonstratively shown in FIG. 1, the representation of the interface of the mobile communication device 110 displayed in the display area 120 may include a navigational map generated from a navigational application installed in the mobile communication device 110. More specifically, the mobile communication device 110 may transmit navigational information (e.g., based on data from a GPS unit of the device 110 indicating a current location, map and routing data obtained by the device 110 from a remote server, etc.) to the CAN bus 210 via the established connection, and the CAN bus 210 may display (e.g., via a display means) a navigational map in the display area 120 based on the received navigational information. This way, the pre-existing hardware and/or software of the mobile communication device 110 can be leveraged in order achieve additional functionality in the vehicle 100.

Notably, the representation of the mobile communication device 210 interface shown in FIG. 1 is for demonstration purposes only and should not be treated as limiting the displayed information to the depicted image. Rather, the representation of the mobile communication device 210 interface may be arranged or formatted in any suitable manner in accordance with the scope of the present claims. That is, the interface of the mobile communication device 110 may be represented in the display area 120 according to any suitable arrangement or format. Similarly, any information of the mobile communication device 110 may be selected (e.g., by the CAN bus 210) to be displayed in the display area 120.

Vehicle information may also be displayed in the display area 120. Conveniently, vehicle information may be displayed in the display area 120 concurrently with the mobile communication device information, such that the driver may simultaneously view useful information relating to both of the vehicle 100 and the mobile communication device 110. The vehicle information may include any information relating to a state of the vehicle, including, for example, HVAC information, infotainment information, and telematics information.

The mobile communication device information and/or the vehicle information may be displayed in the display area 120 of the vehicle 100 using any display means suitable for displaying such information. For instance, as demonstratively shown in FIG. 1, a projection device (positioned under the rear-view mirror, for example) may project the mobile communication device information and/or the vehicle information onto an area of the dashboard. In this regard, a large portion of the dashboard in the vehicle 100 may be utilized as a projection surface. Additionally, a display screen, such as a light-emitting diode (LED) screen, a liquid crystal device (LCD) screen, or any other suitable display screen technique, may be used for displaying the mobile communication device information and/or the vehicle information.

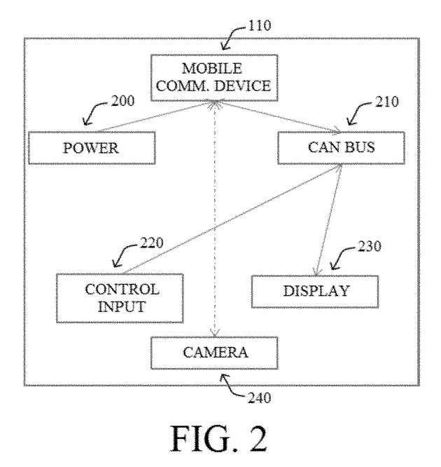

FIG. 2 illustrates an example diagrammatic representation of interaction between components of a vehicle and a mobile communication device. As shown in FIG. 2, a connection may be established between the mobile communication device 110 and the CAN bus 210, thus allowing for information to be transmitted therebetween. The connection may be wired (e.g., via a docking station, USB, Thunderbolt, Lightning, HDMI, etc.) or wireless (e.g., via Bluetooth, Wi-Fi, NFC, etc.). Depending on the connection, the vehicle 100 may supply power to the mobile communication device 110 (e.g., POWER 200 in FIG. 2).

The CAN bus 210 may be configured to receive input for controlling a function of the mobile communication device 110 (e.g., CONTROL INPUT 220 in FIG. 2). Based on the received input, the CAN bus 210 may control a function of the mobile communication device 110. For instance, a driver of the vehicle 100 may desire to navigate to a destination, send an SMS message to a contact, compose an email, launch a particular application, or perform any other function of the mobile communication device 110, while driving the vehicle. Rather than interacting with the mobile communication device 110 directly, which diverts the driver's attention from the road, the driver may safely provide input for controlling the mobile communication device 110 via the CAN bus 210 using a variety of techniques.

In this regard, user input for controlling a function of the mobile communication device 110 may include at least one of: a touch gesture of a user, a motion gesture of the user, a gaze of the user, and a sound of the user. The touch gesture may be sensed at the display area 120. For instance, the touch gesture may be sensed at a touchscreen coupled to the display area 120. Any suitable type of touchscreen technology may be employed, including, for example, a capacitive screen, a resistive/pressure-based screen, and the like. The motion gesture or the gaze may be captured using a camera installed in the vehicle 110. Alternatively, or additionally, the motion gesture or the gaze may be captured using the camera 240 of the mobile communication device 110.

Then, based on the received input, the CAN bus 210 may identify a particular gesture of the user which is linked with a particular function of the mobile communication device 110. For instance, the action may be associated with at least one of: a motion of the user, a sound of the user, a gaze of the user, and an eye position of the user. Upon identifying the particular gesture, the CAN bus 210 may control the mobile communication device 110 via the connection such that the corresponding function is performed by the mobile communication device 110 (e.g., making a call, sending an SMS message, initiating a navigation to a destination, etc.). To this end, the mobile communication device 110 and CAN bus 210 may share applications, such that the CAN bus 210 can perform applications installed in the mobile communication device 110, thus allowing for a seamless integration and functional continuity for the user upon entering the vehicle 100. Furthermore, an application may be installed in the mobile communication device 120 that facilitates the device's ability to control a function of the vehicle through the CAN bus 210.

The CAN bus 210 can cause/transmit information to be displayed in the display area 120 (e.g., on the vehicle dashboard), as described above, using a display device 230, such as a LED-based screen, a LCD-based screen, a projection device (e.g., a pico-projector or the like), or any other device suitable for displaying information in a vehicle (e.g., DISPLAY 230 in FIG. 2). For instance, regarding the mobile communication device information, the display device 230 may display a substantially exact replication of an interface as it appears on the mobile communication device 110 in the display area 120. Or, an alternate or abbreviated representation of the interface of the mobile communication device 110 may be displayed in the display area 120.

Additionally, the CAN bus 210 can cause/transmit vehicle information to be displayed in the display area 120 using the display device 230. The vehicle information may relate to, for example, a HVAC system, telematics (e.g., GPS navigation, safety-related communications, driving assistance systems, etc.), infotainment (e.g., media content, social media content, personalized content, etc.), and so forth. The vehicle information may simply be presented as status information or may include controls enabling the user to adjust vehicle settings.

Moreover, the layout of the displayed mobile communication device information and/or displayed vehicle information in the display area 120 may be customized by the user according to his or her preferences. That is, the CAN bus 210 can adjust an appearance of the displayed representation of the interface of the mobile communication device 110 in the display area 120 according to received input. In particular, users have the ability to arrange applications, windows, and information along the dashboard (e.g., in the display area 120) as desired. For instance, a user may use a touch gesture at a touchscreen coupled to the display area 120 in order to select and drag a particular window, information grouping, image, or the like, to another location, or to remove it completely. Further, the user may select (or remove), and then position, additional information of the mobile communication device 110 or vehicle 100 to be displayed in the display area 120.

The camera 240 of the mobile communication device 110 may also be utilized by the CAN bus 210 in order to enhance functionality of the vehicle 100 (e.g., CAMERA 240 in FIG. 2). Regarding the camera 240 of the mobile communication device 110 in particular, image information acquired by the camera 240 may be transmitted from the mobile communication device 110 to the CAN bus 210 via the connection. Based on the received image information, the CAN bus 210 can control a function of the vehicle, thus leveraging pre-existing hardware and/or software in the mobile communication device 110. For instance, the CAN bus 210 may perform a safety-related function associated with the vehicle 100 based on the image information acquired by the camera 240 of the mobile communication device 110. That is, the camera 240 may be utilized by the CAN bus 210 of the vehicle 100 as a vehicle safety sensor (effectively positioning the mobile communication device 110 can allow the camera 240 to acquire useful image information—behind the rear-view mirror, for example). Such safety-related function may relate to at least one of, for example, a lane keeping assist system (LKAS), a lane departure warning (LDW), pedestrian detection, forward collision warning (FCW), adaptive cruise control (ACC), and the like. Additional vehicular features may also be performed based on image information acquired by the camera 240, including, for example, driver monitoring, convenience-related features (e.g., controlling in-vehicle settings according to the motion, eye position, or gaze direction of the driver), and the like.

Other hardware-based components and/or software of the mobile communication device 110 may be leveraged by the CAN bus 210 in the above manner, as well. That is, the CAN bus 210 may receive, via the established connection, additional information from the mobile communication device 110 acquired by a hardware-based component of the mobile communication device 110 other than the camera 240. The hardware-based components may include, for example, an ambient light sensor, a global positioning system (GPS) unit, an accelerometer, a gyroscope, a microphone, a compass, a barometer, and the like.

As an example, the CAN bus 210 may perform a navigation-related function associated with the vehicle 100 based on navigation information acquired by the mobile communication device 110. In this regard, a GPS unit of the mobile communication device 110 may acquire a current location of the device 110 (as well as the vehicle 100, as the mobile communication device 110 resides therein), and the mobile communication device 110 may transmit the same (i.e., navigational information) to the CAN bus 210. Furthermore, the mobile communication device 110 may determine an optimal route from the determined current location to a chosen destination using a navigation application installed on the device 110. The routing information may also be transmitted to the CAN bus 210. Based on the received information, the CAN bus 210 may, for example, cause the optimal route to be displayed in the display area 120, routing instructions to be audibly outputted to the driver, update the current location of the vehicle 100 as the mobile communication device 110 detects an updated current location (using the GPS unit), and so forth. A wide variety of other ways for leveraging the hardware and/or software of the mobile communication device 110 may also be envisioned.

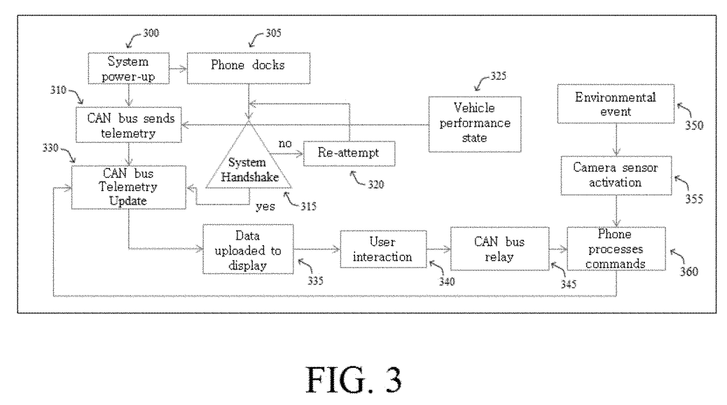

FIG. 3 illustrates an example diagrammatic flowchart of interaction between the CAN bus and the mobile communication device during vehicular and mobile communication device connectivity. The depicted procedure may start at step 300, and continue to step 305 or 310, where, as described in greater detail above, connectivity between the mobile communication device 110 and the CAN bus 210 can be achieved.

At step 300, the CAN system is initialized (i.e., powered-up), at which point the CAN bus 210 obtains an initial telemetry status of the vehicle 100 (step 310). Meanwhile, a connection between the mobile communication device 110 (illustratively referred to as a “phone” in FIG. 3) and the CAN bus 210 is attempted (step 305). At step 315, it is determined whether the mobile communication device 110 and CAN bus 210 are connected to one another (i.e., is there a “handshake”?). If not, the connection may be re-attempted (step 320). If, for example, the mobile communication device 110 and the CAN bus 210 are still disconnected after three consecutive attempts, the procedure shown in FIG. 3 may be aborted.

If a connection between the mobile communication device 110 and the CAN bus 210 is a successful, the CAN bus 210 obtains a telemetry status update of the vehicle 100 (step 330). At step 335, the telemetry status information is then uploaded to the display area 120. In other words, the display device 230 displays vehicle information including the updated telemetry information obtained in step 330. At step 340, the user can perform an action as input (e.g., for controlling a function of the mobile communication device 110). The user input may be in the form of a touch gesture at the display area 120, a motion gesture, a gaze, a sound, or the like. The user input may then be processed by the CAN bus 210 in order to determine a function of the motion communication device 110 corresponds to the identified user input (step 345).

Meanwhile, environmental events may occur, either in the cabin of the vehicle (e.g., a motion of the driver, a gaze of the driver, etc.) or outside of the vehicle (e.g., a pedestrian walks into the road, the vehicle 100 veers into another lane, the vehicle 100 may collide with another object, etc.) (step 350). The mobile communication device 110 can activate its camera 240 so as to capture the occurring environmental event (step 355). Then, at step 360, the mobile communication device 110 processes the image information acquired by the camera 240 in step 355, as well as commands based on user input relayed from the CAN bus 210 to the mobile communication device 110 in step 345. The mobile communication device 110 also performs a function(s) in accordance with control messages relayed by the CAN bus 210 (e.g., make a call, send an SMS message, compose an email, initiate a navigation, etc.). Then, the mobile communication device 110 transmits the information, including image information, to the CAN bus 210, and steps 330-360 can be repeated.

The procedure depicted in FIG. 3 illustratively ends when the established connection between the mobile communication device 110 and the CAN bus 210 is terminated (e.g., upon disconnecting/undocking the mobile communication device 110, turning off the vehicle 100, etc.). The techniques by which the steps of the depicted procedure may be performed, as well as ancillary procedures and parameters, are described in detail above.

It should be noted that the steps shown in FIG. 3 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Even further, the illustrated steps may be modified in any suitable manner in accordance with the scope of the present claims.

Accordingly, techniques are described herein that enhance vehicular and mobile communication device connectivity, thereby increasing user convenience and accessibility, while minimizing security risks and driver distraction, as the driver no longer needs to interact directly with the mobile communication device. Because the vehicle and the mobile communication device can be seamlessly integrated, the driver does not need to learn or perform different techniques to control his or her mobile communication device while in a vehicle; instead, the driver can perform the same functions to control the mobile communication device that are used when the driver is not in the vehicle. Furthermore, the display area displaying the representation of the mobile communication device interface can be personalized according to the driver's preferences. Even further, pre-existing hardware and/or software of the mobile communication device can be leveraged to provide additional in-vehicle functionality, relating to safety, navigation, infotainment, and the like.

While there have been shown and described illustrative embodiments that provide for a system and method for vehicular and mobile communication device connectivity, it is to be understood that various other adaptations and modifications may be made within the spirit and scope of the embodiments herein. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
establishing a connection between a mobile communication device and a controller area network (CAN) bus in a CAN of a vehicle;
receiving, via the established connection, information from the mobile communication device, including image information acquired by a camera of the mobile communication device;
displaying vehicle information and a representation of an interface of the mobile communication device based on the information received from the mobile communication device in a display area of the vehicle;
receiving input for controlling a function of the mobile communication device; and
controlling, via the established connection, the function of the mobile communication device according to the received input.

2. The method of claim 1, further comprising:
controlling a function of the vehicle based on the information received from the mobile communication device.

3. The method of claim 1, further comprising:
performing a safety-related function associated with the vehicle based on the image information acquired by the camera of the mobile communication device.

4. The method of claim 3, wherein the safety-related function relates to at least one of: a lane keeping assist system (LKAS), a lane departure warning (LDW), pedestrian detection, forward collision warning (FCW), and adaptive cruise control (ACC).

5. The method of claim 1, further comprising:
performing a navigation-related function associated with the vehicle based on navigation information acquired by the mobile communication device.

6. The method of claim 1, further comprising:
receiving, via the established connection, additional information from the mobile communication device acquired by a hardware-based component of the mobile communication device other than the camera.

7. The method of claim 6, wherein the hardware-based component includes: an ambient light sensor, a global positioning system (GPS) unit, an accelerometer, a gyroscope, a microphone, a compass, or a barometer.

8. The method of claim 1, wherein the input for controlling the function of the mobile communication device includes at least one of: a touch gesture of a user, a motion gesture of the user, a gaze of the user, and a sound of the user.

9. The method of claim 8, further comprising:
sensing the touch gesture at a touchscreen coupled to the display area.

10. The method of claim 8, further comprising:
capturing the motion gesture or the gaze using a camera installed in the vehicle.

11. The method of claim 8, further comprising:
capturing the motion gesture or the gaze using a camera of the mobile communication device.

12. The method of claim 1, further comprising:
identifying a particular gesture which is linked with a particular function of the mobile communication device based on the received input, the action being associated with at least one of: a motion of a user, a sound of the user, a gaze of the user, and an eye position of the user.

13. The method of claim 1, further comprising:
supplying power to the mobile communication device.

14. The method of claim 1, further comprising:
establishing the connection between the mobile communication device and the CAN bus via a wired connection.

15. The method of claim 1, further comprising:
establishing the connection between the mobile communication device and the CAN bus via a wireless connection.

16. The method of claim 1, further comprising:
establishing the connection between the mobile communication device and the CAN bus via a docking station in the vehicle.

17. The method of claim 16, wherein the docking station is located behind a rear-view mirror of the vehicle.

18. The method of claim 1, further comprising:
concurrently displaying the vehicle information and the representation of the interface of the mobile communication device in the display area.

19. The method of claim 1, wherein the displayed vehicle information is associated with at least one of: heating, ventilation, and air conditioning (HVAC) information, infotainment information, and telematics information.

20. The method of claim 1, further comprising:
adjusting an appearance of the displayed representation of the interface of the mobile communication device in the display area according to received input.

21. A system comprising:
a vehicle including a controller area network (CAN) bus in a CAN of the vehicle; and
a mobile communication device connected to the CAN bus,
wherein the CAN bus: i) receives, via the connection, information from the mobile communication device, including image information acquired by a camera of the mobile communication device, ii) displays vehicle information and a representation of an interface of the mobile communication device based on the information received from the mobile communication device in a display area of the vehicle, iii) receives input for controlling a function of the mobile communication device, and iv) controls, via the connection, the function of the mobile communication device according to the received input.

22. A system comprising:
a vehicle including a controller area network (CAN) bus in a CAN of the vehicle; and
a mobile communication device connected to the CAN bus,
wherein the CAN bus: i) receives, via the connection, information from the mobile communication device, including image information acquired by a camera of the mobile communication device, ii) displays vehicle information and a representation of an interface of the mobile communication device based on the information received from the mobile communication device in a display area of the vehicle, and iii) controls a function of the vehicle based on the information received from the mobile communication device.
